(19) United States
(12) Patent Application Publication
(10) Pub. No.: US 2006/0036882 A1
(43) Pub. Date: Feb. 16, 2006

(54) Display apparatus and display system

(76) Inventor: Young-chan Kim, Eulwang-si (KR)

Correspondence Address: STANZIONE & KIM, LLP, 919 18TH STREET, N.W., SUITE 440, WASHINGTON, DC, 20006, US

(21) Appl. No.: 11/178,288

(22) Filed: Jul. 12, 2005

(30) Foreign Application Priority Data
Aug. 16, 2004 (KR) 2004-64344

(51) Int. Cl. G06F 1/26

(52) U.S. Cl. 713/300

(57) ABSTRACT

A display apparatus connected to a computer through a data communication line includes a power supply to supply electric power, a memory storing to display data, a micro control unit to read the display data from the memory and to transmit the read data to the computer through the data communication line when the electric power is supplied from the power supply, and a switch to connect the data communication line with the micro control unit when the electric power is supplied from the power supply and to connect the data communication line with the memory when the electric power is not supplied from the power supply. Thus, the display apparatus has a simple structure without an additional memory to transmit the display data stored in the memory to the computer.

### CROSS-REFERENCE TO RELATED APPLICATIONS

This application claims the benefit under 35 U.S.C. §119 of Korean Patent Application No. 2004-64344, filed on Aug. 16, 2004, in the Korean Intellectual Property Office, the disclosure of which is incorporated herein in its entirety by reference.

### BACKGROUND OF THE INVENTION

1. Field of the Invention

The present general inventive concept relates to a display apparatus and a display system, and more particularly, to a display apparatus and a display system, having an improved structure of transmitting display data.

2. Description of the Related Art

A display apparatus connected to a computer supports a display data channel (DDC) operation.

The DDC is used as a data communication standard between the display apparatus, such as a monitor, and a video graphics array (VGA) card of the computer designated by an industry group called the video electronics standards association (VESA), so that an optimum picture is displayed by allowing the VGA card to refer to display data of the display apparatus while the computer is booted.

Accordingly, a micro control unit (MCU) manufacturer has manufactured an MCU comprising a built-in block supporting the DDC operation, thereby allowing the display system to perform the DDC operation without a separate external DDC device.

FIG. 1 is a schematic block diagram of a conventional display apparatus 10 comprising an MCU 13 supporting a DDC operation, and an electrical erasable programmable read only memory (EEPROM) 15 storing display data.

Referring to FIG. 1, in the case in which the DDC operation is performed using the MCU 13, the MCU 13 receives electric power from a power supply 11 when the display apparatus 10 is turned on, and reads extended display identification data (EDID) from the EEPROM 15, thereby loading the EDID into a DDC register.

When a computer 20 requests the EDID, the EDID stored in the DDC register is transmitted from a connector 16 of the display apparatus 10 to a connector 26 of the computer 20 through a data line (DDC SDL) of a DDC communication line corresponding to a DDC clock signal transmitted through a clock line (DDC SCL) of the DDC communication line.

On the other hand, when the display apparatus 10 is turned off, the computer 20 supplies external electric power to the display apparatus 10 through a predetermined power pin (DDC POWER) of the DDC communication line in order to read the EDID from the display apparatus 10. However, in this case, there arises a problem in that a large amount of the external electric power must be consumed to perform the DDC operation because both the MCU 13 and the EEPROM 15 must be turned on.

To solve this problem, an additional EEPROM 17 storing the EDID can be provided for performing the DCC operation as shown in FIG. 2. The additional EEPROM 17 receives the external electric power from the computer 20 when the electric power is not supplied from the power supply 11 of the display 10, so that the computer 20 can directly communicate with the additional EEPROM 17 without passing through the MCU 13 to read the EDID stored in the additional EEPROM 17. However, in this case, there arises a problem in that the additional EEPROM 17 is needed.

### SUMMARY OF THE INVENTION

Accordingly, the present general inventive concept provides a display apparatus and a display system, having a simple structure without an additional memory to transmit display data stored in a memory to a computer.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a display apparatus connected to a computer through a data communication line, the display apparatus comprising a power supply to supply electric power to an inner system, a memory to store display data, a micro control unit to read the display data from the memory and to transmit the read display data to the computer through the data communication line when the electric power is supplied from the power supply, and a switch to connect the data communication line with the micro control unit when the electric power is supplied from the power supply and to connect the data communication line with the memory when the electric power is not supplied from the power supply.

The micro control unit may control the switch to connect the data communication line with the micro control unit when the electric power is supplied from the power supply.

The display data stored in the memory may be transmitted to the computer through the data communication line when the data communication line is connected to the memory.

The micro control unit may control the switch to connect the data communication line with the micro control unit after a predetermined time elapses when the electric power is supplied from the power supply while the display data is read from the memory.

The display data may be stored in a first page of the memory.

The foregoing and/or other aspects and advantages of the present general inventive concept may also be achieved by providing a display system comprising a display apparatus including a power supply to supply electric power to an inner system, a memory to store display data, a micro control unit to read the display data from the memory and to transmit the read display data to a computer through a data communication line when the electric power is supplied from the power supply, and a switch to connect the data communication line with the micro control unit when the electric power is supplied from the power supply and to connect the data communication line with the memory when the electric power is not supplied from the power supply, and the computer to read the display data from the memory when the data communication line is connected to the memory.

The micro control unit may control the switch to connect the data communication line with the micro control unit after a predetermined time elapses when the electric power is supplied from the power supply to the micro control unit while the computer reads the display data from the memory.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a conventional display system to perform a DDC operation;

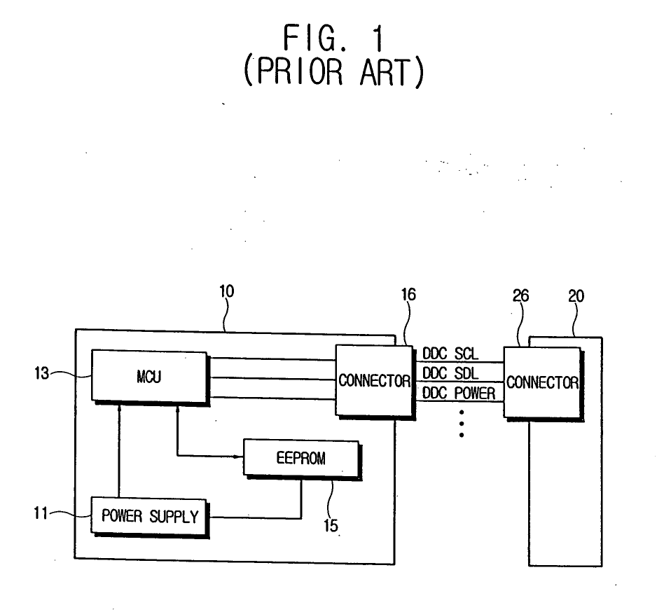

FIG. 2 is a schematic block diagram of a conventional display system comprising an additional EEPROM to perform the DDC operation;

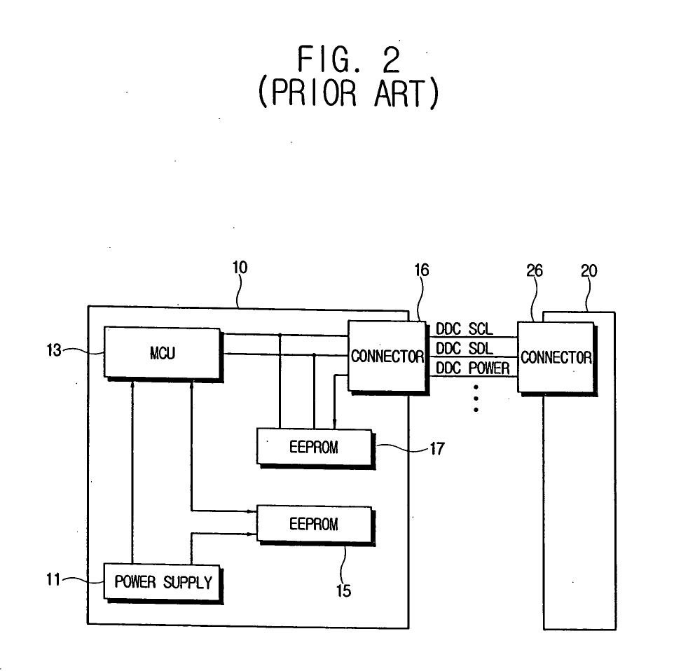

FIG. 3 is a schematic block diagram of a display system according to an embodiment of the present general inventive concept;

FIG. 4 is a schematic block diagram of a display system according to another embodiment of the present general inventive concept;

FIG. 5 is a control flowchart of the display system of FIG. 4; and

FIG. 6 is a table first page of an EEPROM according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

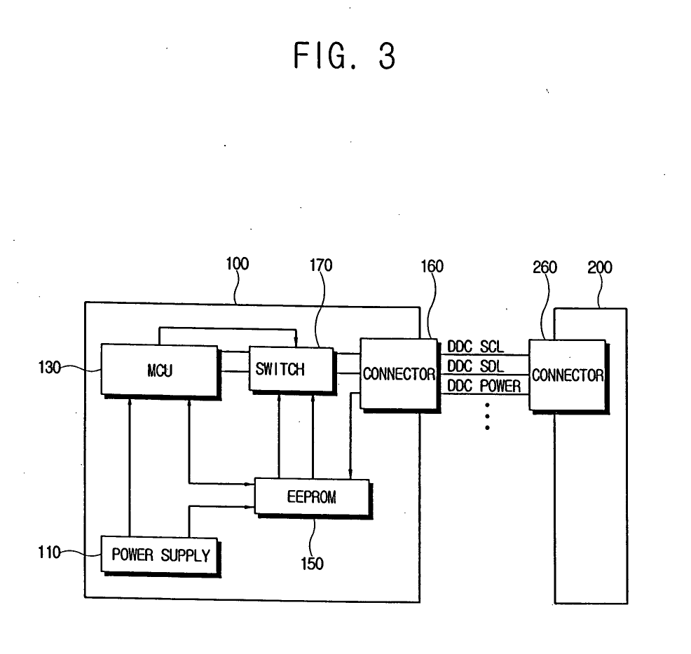

FIG. 3 is a schematic block diagram of a display system according to an embodiment of the present general inventive concept.

Referring to FIG. 3, the display system comprises a display apparatus 100 and a computer 200. The display apparatus comprises a power supply 110, an MCU (micro control unit) 130, an EEPROM (electrical erasable programmable read only memory) 150, a connector 160, and a switch 170. The computer 200 comprises a connector 200 connected to the display apparatus 100 through a data communication line.

The display apparatus 100 and the computer 200 can be connected through a DDC (display data channel) communication line, which is used as the data communication line. Here, the DDC communication line comprises a data line (DDC SDL), a clock line (DDC SCL), and a 5V-power line (DDC POWER).

When electric power is not supplied from the power supply 110 to an inner system of the display apparatus 100, that is, when the display apparatus 100 is turned off, the computer 200 supplies an external electric power of 5V to the display apparatus 100 through the 5V-power line (DDC POWER). For example, the external electric power of 5V can be supplied from the computer 200 to the display apparatus 100 through a D_SUB 9^{th} pin.

The EEPROM 150 stores display data related to the display apparatus 100. The EEPROM 150 can store a setting value related to a resolution by a parameter varying according to units in a manufacturing process.

Here, the display data can include EDID (extended display identification data).

The EEPROM 150 receives the electric power from the power supply 110, or receives the external electric power from the computer 200 through the 5V-power line (DDC POWER) of the DDC communication line when the electric power is not supplied from the power supply 110.

When the display apparatus 100 is turned on, the inner system is supplied with the electric power from the power supply 110 and the MCU 130 reads the EDID from the EEPROM 150 and loads the EDID into a DDC register.

Here, when the computer 200 reads the EDID, the data stored in the DDC register is transmitted to the computer 200 through the data line (DDC SDL) of the DDC communication line corresponding to a DDC clock signal transmitted through the clock line (DDC SCL) of the DDC communication line.

The computer 200 recognizes characteristics of the display apparatus 100 based on the received EDID, and outputs a video signal corresponding to the characteristics of the display apparatus 100.

Further, the MCU 130 can control the EEPROM 150 to store data related to an adjusted setting value when a user adjusts the setting value of the display apparatus 100.

The MCU 130 and the EEPROM 150 can communicate with each other by an open-drop collector.

The switch 170 electrically connects the DDC communication line with the MCU 130 when the display apparatus 100 is turned on, and electrically connects the DDC communication line with the EEPROM 150 when the inner system of the display apparatus 100 is turned off.

For example, when the inner system is supplied with the electric power from the power supply 110, a high signal can be applied to the switch 170 from the power supply 110 to connect the DDC communication line with the MCU 130.

The MCU 130 then reads the EDID from the EEPROM 150, loads the EDID into the DDC register and transmits the EDID to the computer 200 through the DDC communication line.

On the other hand, when the inner system is not supplied with the electric power from the power supply 110, a low signal can be applied as a default value to the switch 170 from the computer 200 to connect the DDC communication line with the EEPROM 150.

The computer 200 then supplies the external electric power to the display apparatus 100 through the 5V-power line (DDC POWER). Thus, the computer 200 directly communicates with the EEPROM 150 without passing through the MCU 130, to thereby read the EDID stored in the EEPROM 150.

The computer 200 and the EEPROM 150 can directly communicate with each other by I2C-communication.

The switch 170 is not limited to the example described above, and can be variously designed to be switched according to whether the inner system is supplied with the electric power from the power supply 110 or not.

The MCU 130 can control the switch 170 to be switched, for example, the MCU 130 can control the switch 170 to be switched to connect the DDC communication line with the MCU 130 when the display apparatus 100 is turned on.

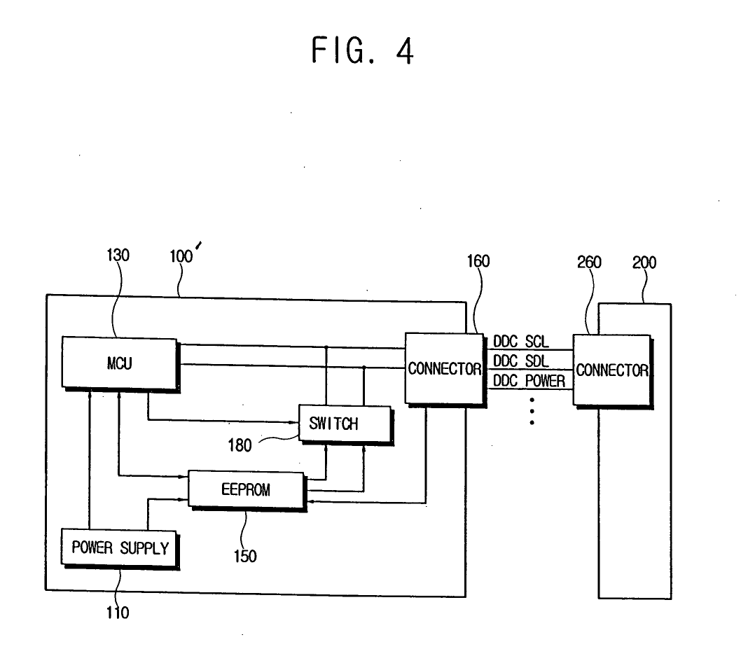

FIG. 4 is a schematic block diagram of a display system according to another embodiment of the present general inventive concept. Hereinbelow, like reference numerals refer to like elements, and repetitive descriptions will be omitted.

Referring to FIG. 4, a switch 180 of a display apparatus 100′ is only switched to connect the EEPROM 150 and the DDC communication.

Accordingly, the DDC communication line is protected from an error generated by a DDC operation change while the computer 200 reads the EDID. Here, the MCU 130 counts time elapsed from when the power supply 110 begins supplying the electric power, while determining whether the EEPROM 150 and the computer 200 are communicating with each other through the DDC communication line, to thereby control the switch 180.

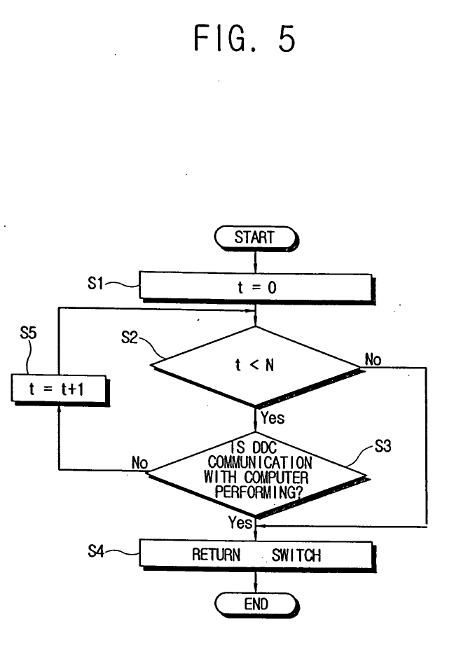

FIG. 5 is a control flow of the display system of FIG. 4.

Referring to FIGS. 4 and 5, when the display apparatus 100′ is turned off, the switch 180 is switched to connect the DCC communication line with the EEPROM 150, so that the computer 200 can directly communicate with the EEPROM 150 to read the EDID of the display apparatus 100′.

If the display apparatus is turned on while the computer 200 is reading the EDID from the EEPROM 150, the MCU 130 receives the electric power and starts counting the time at operation S1.

At operation S2, the MCU 130 determines whether the counted time is smaller than a predetermined time of N. In the case where the counted time is smaller than the predetermined time of N, at operation S3, the MCU 130 determines whether the computer 200 and the EEPROM 150 are communicating with each other through the DDC communication line.

When it is determined that the computer 200 and the EEPROM 150 are not communicating with each other, at operation S4, the switch 180 is switched to connect the DDC communication line with the MCU 130. Meanwhile, if the computer 200 is communicating with the EEPROM 150 through the DDC communication line, at operation S5, the MCU 130 continues to count the time.

Here, when it is determined that the counted time reaches the preset time of N, even if the computer 200 is communicating with the EEPROM 150 through the DDC communication line, at operation S4, the switch 180 is switched to connect the DDC communication line with the MCU 130 to prevent an infinite loop.

Thus, the DDC communication is protected from an error while the computer 200 reads the EDID.

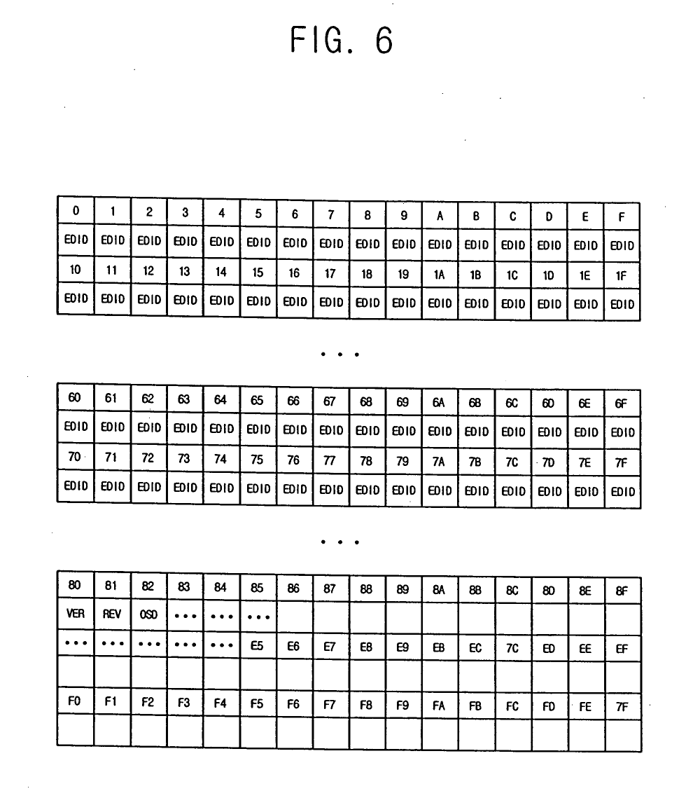

FIG. 6 shows a first page (0-page) of the EEPROM 150.

As shown in FIG. 6, the EEPROM 150 can store general display data as well as the EDID.

In the case in which the MCU 130 performs the DDC operation, it may not be necessary to store the EDID in the first page (0-page) of the EEPROM 150. On the other hand, in the case in which the EEPROM 150 directly communicates with the computer 200, the first page (0-page) of the EEPROM 150 should store the EDID because the computer 200 may need the EDID in the first page (0-page). Accordingly, the EEPROM 150 stores the EDID in the first page (0-page) and other data, for example, VER, REV, or OSD data, following the EDID.

As described above, the DDC communication line is employed as the data communication line, and the EEPROM is employed as a memory. However, other data communication lines and other memories can alternatively be used.

As described above, the present general inventive concept provides a display apparatus and a display system, having a simple structure without an additional memory to transmit display data stored in a memory to a computer.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus connected to a computer through a data communication line, comprising:
a power supply to supply electric power;
a memory to store display data;
a micro control unit to read the display data from the memory and to transmit the read display data to the computer through the data communication line when the electric power is supplied from the power supply; and
a switch to connect the data communication line with the micro control unit when the electric power is supplied from the power supply, and to connect the data communication line with the memory when the electric power is not supplied from the power supply.

2. The display apparatus according to claim 1, wherein the micro control unit controls the switch to connect the data communication line with the micro control unit when the electric power is supplied from the power supply.

3. The display apparatus according to claim 2, wherein the micro control unit detects whether the computer is reading the display data from the memory when the electric power is supplied from the power supply, and controls the switch to connect the computer to the micro control unit through the data communication line when the computer is not reading the display data from the memory.

4. The display apparatus according to claim 1, wherein the display data stored in the memory is transmitted to the computer through the data communication line when the data communication line is connected to the memory.

5. The display apparatus according to claim 4, wherein the micro control unit controls the switch to connect the data communication line with the micro control unit after a predetermined time elapses from when the electric power is supplied from the power supply while the display data stored in the memory is being transmitted to the computer.

6. The display apparatus according to claim 5, wherein the display data is stored in a first page of the memory.

7. The display apparatus according to claim 4, wherein the display data is stored in a first page of the memory.

8. The display apparatus according to claim 1, wherein the display data comprises extended display identification data (EDID).

9. The display apparatus according to claim 1, wherein the data communication line comprises a display data channel (DDC) communication line.

10. A display system comprising:
a display apparatus comprising a power supply to supply electric power to an inner system, a memory to store display data, a micro control unit to read the display data from the memory and to transmit the read display data to a computer through a data communication line when the electric power is supplied from the power supply, and a switch connecting the data communication line with the micro control unit when the electric power is supplied from the power supply and connecting the data communication line with the memory when the electric power is not supplied from the power supply; and
the computer to read the display data from the memory when the data communication line is connected to the memory.

11. The display system according to claim 10, wherein the micro control unit controls the switch to connect the data communication line with the micro control unit after a predetermined time elapses from when the electric power is supplied from the power supply to the micro control unit while the computer reads the display data from the memory.

12. The display system according to claim 10, wherein the data communication line comprises a display data channel (DDC) communication line.

13. The display system according to claim 10, wherein the micro control unit detects whether the computer is reading the display data from the memory when the electric power is supplied from the power supply, and controls the switch to connect the computer to the micro control unit through the data communication line when the computer is not reading the display data from the memory.

14. A display apparatus communicating with an external computer, comprising
a connector to communicate with an external computer;
a memory to store display data, and connected to the connector to form a first path through which the display data is transmitted to the external computer; and
a micro control unit connected to the connector to form a second path through which the display data stored in the memory is transmitted to the external computer.

15. The display apparatus according to claim 14, further comprising:
a power supply to supply power to the micro control unit and the memory,
wherein the display data is transmitted through the first path when the power supply is turned off, and through the second path when the power supply is turned on.

16. The display apparatus according to claim 14, wherein the display data comprises extended display identification data (EDID) stored in a first page of the memory.
